(19) United States
(12) Patent Application Publication
(10) Pub. No.: US 2026/0179846 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Eun Kyung CHOI, Suwon-si (KR); Chung Eun LEE, Suwon-si (KR)

(73) Assignee: SAMSUNG ELECTRO-MECHANICS CO., LTD., Suwon-si (KR)

(21) Appl. No.: 19/364,392

(22) Filed: Oct. 21, 2025

(30) Foreign Application Priority Data
Dec. 20, 2024 (KR) 10-2024-0193071

(51) Int. Cl. H01G 4/232; H01G 2/06; H01G 4/008; H01G 4/012; H01G 4/12; H01G 4/30

(52) U.S. Cl. CPC H01G 4/232; H01G 2/065; H01G 4/008; H01G 4/012; H01G 4/12; H01G 4/30

(57) ABSTRACT

A multilayer electronic component includes a body including a dielectric layer and internal electrode layers, the body surfaces opposing each other in first to third directions, perpendicular to each other, and a plurality of external electrodes disposed on a surface in the third direction and a surface in the second direction of the body. At least a portion of the body has a concave shape in an inward direction of the body. A length, from the body, of each of the external electrodes disposed on the surface in the third direction of the body is greater than a length, from the body, of each of the external electrodes disposed on the surface in the second direction of the body, and is greater than or less than a maximum length.

### CROSS-REFERENCE TO RELATED APPLICATION

This application claims benefit of priority to Korean Patent Application No. 10-2024-0193071 filed on Dec. 20, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

The multilayer ceramic capacitor may be used as a component of various electronic devices due to having a small size, ensuring high capacitance and being easily mounted. With the miniaturization and high-output power of various electronic devices such as computers and mobile devices, demand for miniaturization and implementation of high capacitance in multilayer ceramic capacitors has also been increasing.

A body of a multilayer electronic component may include a ceramic material, and accordingly, a step portion may be formed when the multilayer electronic component, including external electrodes formed thereon, is mounted on a board, due to shrinkage of ceramic particles during a sintering process. Alternatively, as internal electrodes (layers) having different shapes are repeatedly stacked, the body may have a step portion. As a result, when the multilayer electronic component, including external electrodes formed thereon, is mounted on the board, a step portion may also be formed. A step portion during mounting may cause mounting defects and more easily induce defects in the component. Accordingly, minimizing a step portion during mounting to improve planarity of the body during mounting may also be one of the important challenges.

### SUMMARY

An aspect of the present disclosure is to provide a multilayer electronic component having an improved mounting rate.

Another aspect of the present disclosure is to provide a multilayer electronic component having a minimized step portion during mounting.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and first and second internal electrode layers alternately disposed in a first direction with the dielectric layer interposed therebetween, the body having first and second surfaces opposing each other in the first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, first and second external electrodes respectively disposed on the third and fourth surfaces, the first and second external electrodes disposed to extend to portions of the first and second surfaces, and third and fourth external electrodes respectively disposed on the fifth and sixth surfaces, the third and fourth external electrodes disposed to extend to portions of the first and second surfaces. When the multilayer electronic component is observed in the third direction, a length in the first direction of each of both end portions in the second direction of the body may be greater than a length in the first direction of a central portion in the second direction of the body. A maximum length in the first direction of each of regions of the third and fourth external electrodes, disposed to extend to a portion of the first surface, may be greater than a maximum length in the first direction of each of regions of the first and second external electrodes, disposed to extend to a portion of the first surface. A maximum length in the first direction of each of regions of the third and fourth external electrodes, disposed to extend to a portion of the second surface, may be greater than a maximum length in the first direction of each of regions of the first and second external electrodes, disposed to extend to a portion of the second surface. Both ends in the first direction of each of the third and fourth external electrodes may not exceed both ends in the first direction of each of the first and second external electrodes.

According to another aspect of the present disclosure, there is provided a multilayer electronic component including a body including a dielectric layer and first and second internal electrode layers alternately disposed in a first direction with the dielectric layer interposed therebetween, the body having first and second surfaces opposing each other in the first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, first and second external electrodes respectively disposed on the third and fourth surfaces, the first and second external electrodes disposed to extend to portions of the first and second surfaces, and third and fourth external electrodes respectively disposed on the fifth and sixth surfaces, the third and fourth external electrodes disposed to extend to portions of the first and second surfaces. When a cross-section in the first and second directions of at least one of both end portions in the third direction of the multilayer electronic component is observed to include the body and the first to fourth external electrodes, a length in the first direction of each of both end portions in the second direction of the body may be greater than a length in the first direction of a central portion in the second direction of the body. A maximum length in the first direction of each of regions of the third and fourth external electrodes, disposed to extend to a portion of the first surface, may be greater than a maximum length in the first direction of each of regions of the first and second external electrodes, disposed to extend to a portion of the first surface. A maximum length in the first direction of each of regions of the third and fourth external electrodes, disposed to extend to a portion of the second surface, may be greater than a maximum length in the first direction of each of regions of the first and second external electrodes, disposed to extend to a portion of the second surface. Both ends in the first direction of each of the third and fourth external electrodes may not exceed both ends in the first direction of each of the first and second external electrodes.

According to example embodiments of the present disclosure, a composite electronic component may have an improved mounting rate.

According to example embodiments of the present disclosure, a multilayer electronic component may have a minimized step portion during mounting.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a composite electronic component according to an example embodiment of the present disclosure;

FIG. 2 is a schematic perspective view of FIG. 1 in a Y-direction;

FIGS. 3A and 3B are schematically illustrates internal electrode layers according to an example embodiment of the present disclosure;

FIG. 4 is a schematic cross-sectional view taken along line I-I′ of FIG. 1;

FIG. 5 is a schematic cross-sectional view taken along line II-II′ of FIG. 1;

FIG. 6 is a schematic perspective view of a composite electronic component according to another example embodiment of the present disclosure;

FIG. 7 is a schematic perspective view of FIG. 6 in a Y-direction;

FIG. 8 is a schematic cross-sectional view taken along line III-III′ of FIG. 6;

FIG. 9 is a schematic cross-sectional view taken along line IV-IV′ of FIG. 6; and

FIG. 10 is a schematic cross-sectional view taken along line V-V′ of FIG. 6.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a Z-direction may be defined as a first direction, an X-direction may be defined as a second direction, and a Y-direction may be defined as a third direction.

### Multilayer Electronic Component

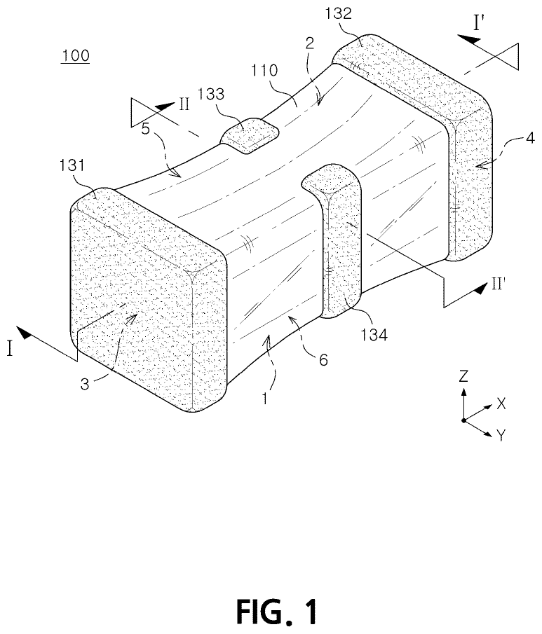

FIG. 1 is a schematic perspective view of a composite electronic component according to an example embodiment of the present disclosure.

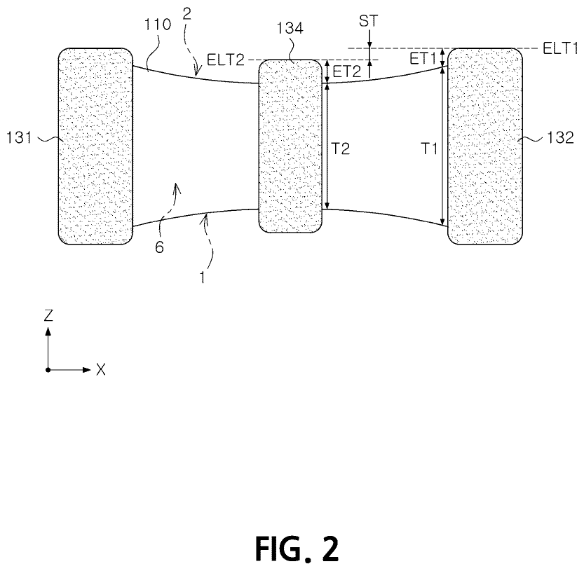

FIG. 2 is a schematic perspective view of FIG. 1 in a Y-direction.

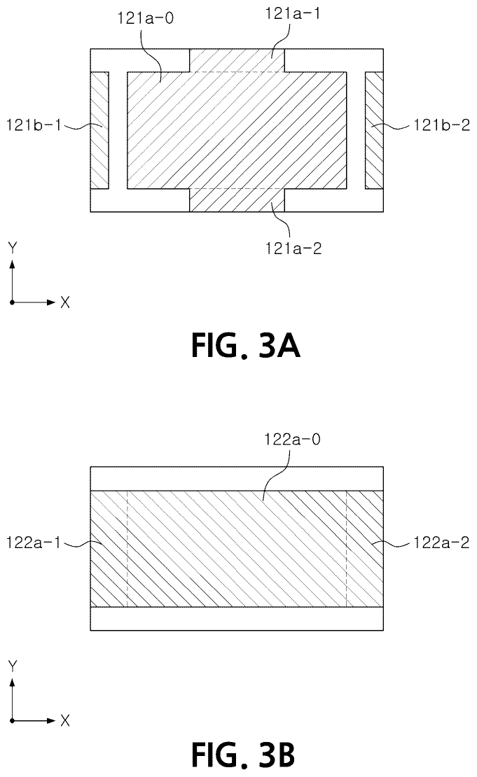

FIGS. 3A and 3B are schematically illustrates internal electrode layers according to an example embodiment of the present disclosure.

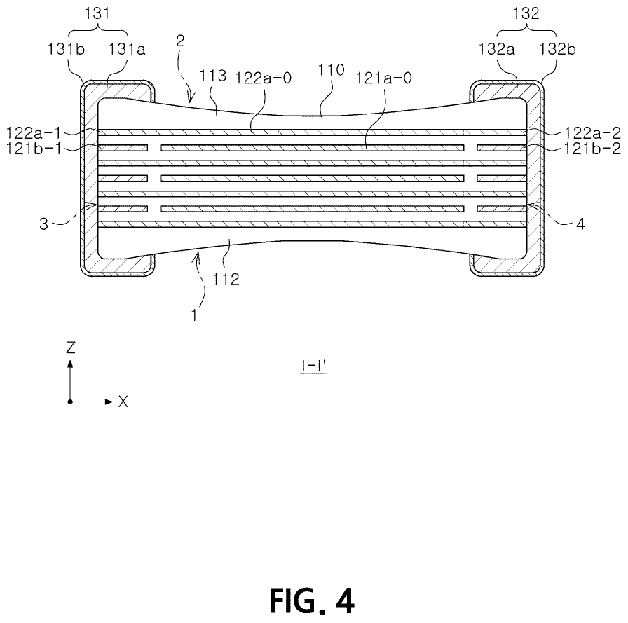

FIG. 4 is a schematic cross-sectional view taken along line I-I′ of FIG. 1.

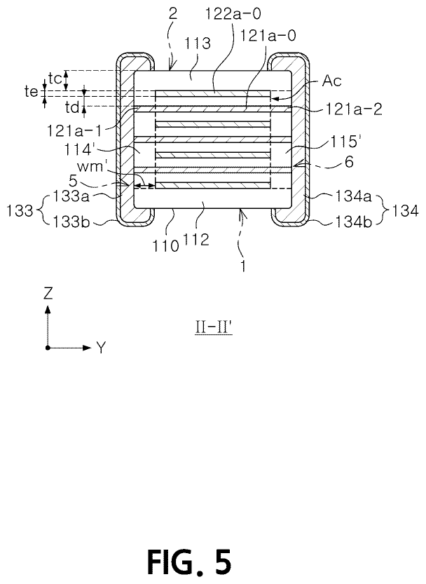

FIG. 5 is a schematic cross-sectional view taken along line II-II′ of FIG. 1.

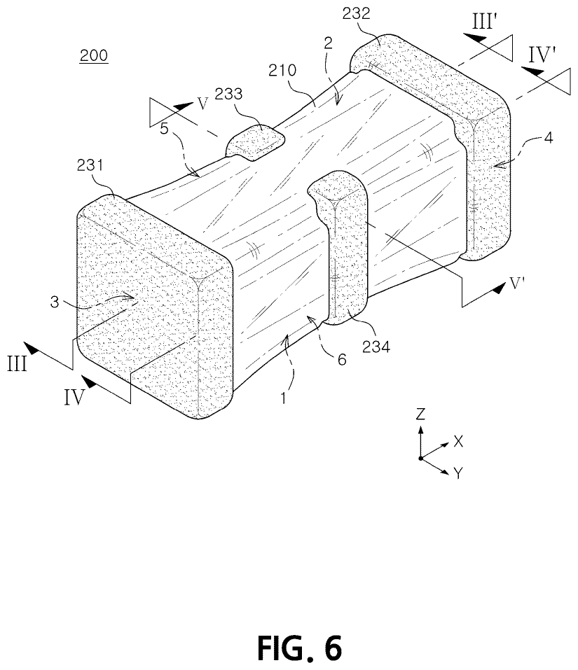

FIG. 6 is a schematic perspective view of a composite electronic component according to another example embodiment of the present disclosure.

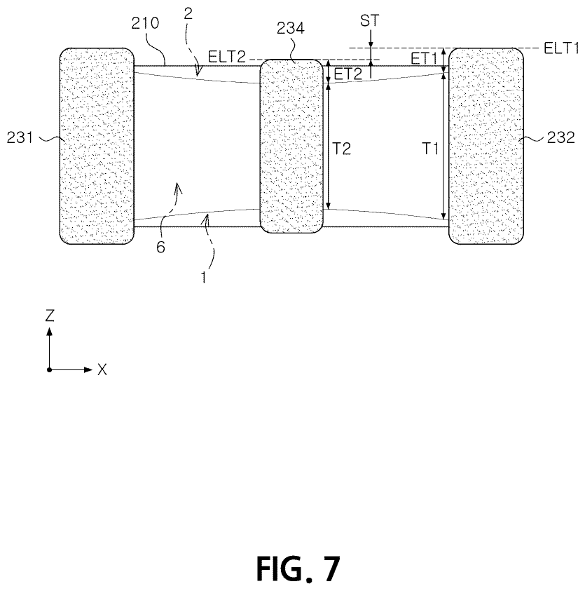

FIG. 7 is a schematic perspective view of FIG. 6 in a Y-direction.

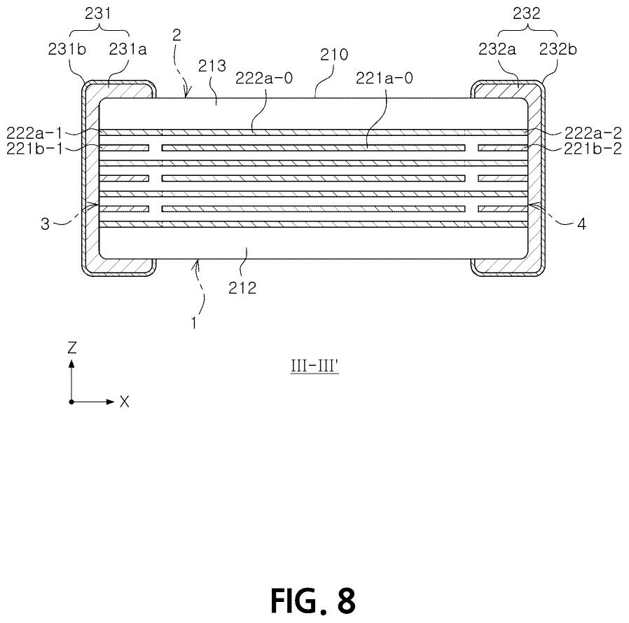

FIG. 8 is a schematic cross-sectional view taken along line III-III′ of FIG. 6.

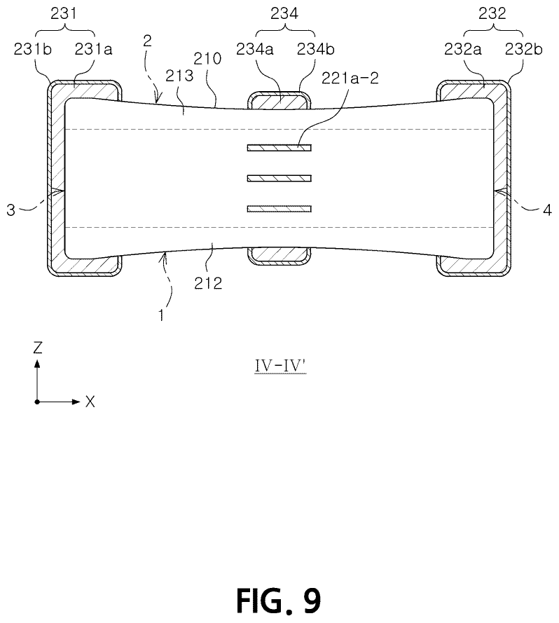

FIG. 9 is a schematic cross-sectional view taken along line IV-IV′ of FIG. 6.

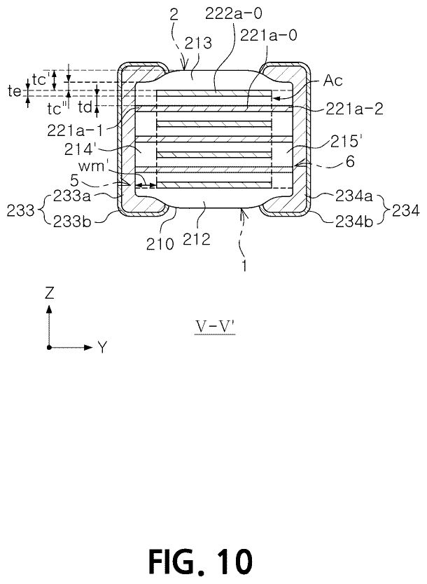

FIG. 10 is a schematic cross-sectional view taken along line V-V′ of FIG. 6.

Hereinafter, a multilayer electronic component according to an example embodiment of the present disclosure will be described in detail with reference to FIGS. 1, 2, 3A, 3B and 4 to 10. A multilayer ceramic capacitor is described as an example of a multilayer electronic component. However, the present disclosure may be applied to various electronic products using a dielectric composition, such as inductors, piezoelectric elements, varistors, thermistors, or the like.

A multilayer electronic component 100 according to an example embodiment of the present disclosure may include a body 110 including a dielectric layer 111 and first and second internal electrode layers 121 and 122 alternately disposed in a first direction with the dielectric layer 111 interposed therebetween, the body 110 having first and second surfaces 1 and 2 opposing each other in the first direction, third and fourth surfaces 3 and 4 connected to the first and second surfaces 1 and 2, the third and fourth surfaces 3 and 4 opposing each other in a second direction, and fifth and sixth surfaces 5 and 6 connected to the first to fourth surfaces 1 to 4, the fifth and sixth surfaces 5 and 6 opposing each other in a third direction, first and second external electrodes 131 and 132 respectively disposed on the third and fourth surfaces 3 and 4, the first and second external electrodes 131 and 132 disposed to extend to portions of the first and second surfaces 1 and 2, and third and fourth external electrodes 133 and 134 respectively disposed on the fifth and sixth surfaces 5 and 6, the third and fourth external electrodes 133 and 134 disposed to extend to portions of the first and second surfaces 1 and 2. When the multilayer electronic component 100 is observed in the third direction, a length in the first direction (T1) of each of both end portions in the second direction of the body 110 may be greater than a length in the first direction (T2) of a central portion in the second direction of the body 110, a maximum length in the first direction of each of regions of the third and fourth external electrodes 133 and 134, disposed to extend to a portion of the first surface 1, may be greater than a maximum length in the first direction of each of regions of the first and second external electrodes 131 and 132, disposed to extend to a portion of the first surface 1, a maximum length in the first direction (ET2) of each of regions of the third and fourth external electrodes 133 and 134, disposed to extend to a portion of the second surface 2, may be greater than a maximum length in the first direction (ET1) of each of regions of the first and second external electrodes 131 and 132, disposed to extend to a portion the second surface 2, and both ends in the first direction (ELT2) of each of the third and fourth external electrodes 133 and 134 may not exceed both ends in the first direction (ELT1) of each of the first and second external electrodes 131 and 132.

A multilayer electronic component 200 according to another example embodiment of the present disclosure may include a body 210 including a dielectric layer 211 and first and second internal electrode layers 221 and 222 alternately disposed in a first direction with the dielectric layer 211 interposed therebetween, the body 210 having first and second surfaces 1 and 2 opposing each other in the first direction, third and fourth surfaces 3 and 4 connected to the first and second surfaces 1 and 2, the third and fourth surfaces 3 and 4 opposing each other in a second direction, and fifth and sixth surfaces 5 and 6 connected to the first to fourth surfaces 1 to 4, the fifth and sixth surfaces 5 and 6 opposing each other in a third direction, first and second external electrodes 231 and 232 respectively disposed on the third and fourth surfaces 3 and 4, the first and second external electrodes 231 and 232 disposed to extend to portions of the first and second surfaces 1 and 2, and third and fourth external electrodes 233 and 234 respectively disposed on the fifth and sixth surfaces 5 and 6, the third and fourth external electrodes 233 and 234 disposed to extend to portions of the first and second surfaces 1 and 2. When a cross-section in the first and second directions of at least one of both ends in the third direction of the multilayer electronic component 200 is observed to include the body 210 and the first to fourth external electrodes 231, 232, 233, and 234, a length in the first direction (T1) of each of both ends in the second direction of the body 210 may be greater than a length in the first direction (T2) of a central portion in the second direction of the body 210, a maximum length in the first direction of each of regions of the third and fourth external electrodes 233 and 234, disposed to extend to a portion of the first surface 1, may be greater than a maximum length in the first direction of each of regions of the first and second external electrodes 231 and 232 disposed to extend to a portion of the first surface 1, a maximum length in the first direction (ET2) of each of regions of the third and fourth external electrodes 233 and 234, disposed to extend to a portion of the second surface 2, may be greater than a maximum length in the first direction (ET1) of each of regions of the first and second external electrodes 231 and 232, disposed to extend to a portion of the second surface 2, and both ends in the first direction (ELT2) of each of the third and fourth external electrodes 233 and 234 may not exceed both ends in the first direction (ELT1) of each of the first and second external electrodes 231 and 232.

Hereinafter, the multilayer electronic component 100 according to an example embodiment of the present disclosure will be described in more detail. However, unless otherwise inconsistent therewith, it will be apparent to those skilled in the art that descriptions of the multilayer electronic component 100 may be equally applied to the multilayer electronic component 200 according to another example embodiment of the present disclosure.

In the body 110, the dielectric layer 111 and the internal electrode layers 121 and 122 may be alternately stacked.

More specifically, the body 110 may include a capacitance formation portion Ac disposed in the body 110, the capacitance formation portion Ac including a first internal electrode layer 121 and a second internal electrode layer 122 alternately disposed to each other with the dielectric layer 111 interposed therebetween to form capacitance.

A specific shape of the body 110 is not limited. However, as illustrated, the body 110 may have a hexahedral shape or a shape similar thereto.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the first to fourth surfaces 1, 2, 3, and 4, the fifth and sixth surfaces 5 and 6 opposing each other in the third direction.

Due to shrinkage of ceramic particles included in the body 110 during a sintering process or due to a step portion between the stacked internal electrode layers 121 and 122, the body 110 may not have a hexahedral shape having perfectly straight lines. However, based on a substantially hexahedral shape, any two opposing surfaces may have, at least partially, a concave shape in an inward direction of the body 110.

More specifically, for example, at least one of the first surface 1 and the second surface 2, opposing each other in the first direction, may have, at least partially, a concave shape in the inward direction of the body 110, and the first surface 1 and the second surface 2 may preferably have, at least partially, a concave shape in the inward direction of the body 110.

That is, in the present disclosure, the first surface 1 and the second surface 2, opposing each other, are not limited to the first surface 1 and the second surface 2, substantially parallel to each other.

In addition, a plurality of dielectric layers 111, included in the body 110, may be in a sintered state, and adjacent dielectric layers 111 may be integrated with each other such that boundaries therebetween are not readily apparent without using a scanning electron microscope (SEM).

A raw material included in the dielectric layer 111 is not limited as long as sufficient capacitance is obtainable therewith. In general, a perovskite (ABO₃)-based material may be used. For example, a barium titanate-based material, a lead composite perovskite-based material, or a strontium titanate-based material may be used. The barium titanate-based material may include BaTiO₃-based ceramic particles. Examples of the ceramic particles may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃.

In addition, a raw material, included in the dielectric layer 111, may be obtained by adding various ceramic additives, organic solvents, binders, dispersants, and the like to particles such as barium titanate (BaTiO₃) depending on the purpose of the present disclosure.

In order to distinguish from a dielectric layer to be described below included in the cover portions 112 and 113, a dielectric layer included in the capacitance formation portion Ac may be defined as a first dielectric layer, and a dielectric layer included in the cover portions 112 and 113 may be defined as a second dielectric layer.

In addition, the first and second dielectric layers may be formed using a dielectric material such as barium titanate (BaTiO₃), and thus may include a dielectric microstructure after sintering. The dielectric microstructure may include a plurality of grains, a grain boundary disposed between adjacent grains, and a triple point disposed at a point with which three or more grain boundaries are in contact, and may include a plurality of grains, a plurality of grain boundaries, and a plurality of triple points.

A length in the first direction (td) of the dielectric layer 111 is not limited.

In order to more easily achieve high capacitance and miniaturization of a multilayer electronic component, a length in the first direction (td) of the dielectric layer 111 may be 3.0 μm or less, 2.0 μm or less, 1.0 μm or less, or 0.8 μm or less, preferably 0.6 μm or less, and more preferably 0.4 μm or less.

Here, the length in the first direction (td) of the dielectric layer 111 may refer to a length in the first direction (td) of the dielectric layer 111, disposed between the first and second internal electrode layers 121 and 122.

In this case, the length in the first direction (td) of the dielectric layer 111 may be based on a concept including a length in the first direction (td) of at least one of the plurality of dielectric layers 111, or may be based on a concept including a length in the first direction (td) of each of all the dielectric layers 111.

In addition, the length in the first direction (td) of the dielectric layer 111 may refer to an average length in the first direction (td) of a single dielectric layer 111, may refer to an average length in the first direction (td) of each of the plurality of dielectric layers 111, or may refer to average lengths in the first direction (td) of the plurality of dielectric layers 111.

The average length in the first direction (td) of the dielectric layer 111 may be measured by scanning, with an SEM, an image of a cross-section of the body 110 in the first and second directions at a magnification of 10,000. More specifically, the average length in the first direction (td) of the single dielectric layer 111 may refer to an average value of lengths in the first direction of the single dielectric layer 111, measured at five points spaced apart from each other at equal intervals in the second direction, in the scanned image. The five points, spaced apart from each other at equal intervals, may be designated in the capacitance formation portion Ac. In addition, when such average value measurement is performed on three dielectric layers 111, the average lengths in the first direction (td) of the plurality of dielectric layers 111 may be further generalized.

The internal electrode layers 121 and 122 may be alternately stacked with the dielectric layer 111.

The internal electrode layers 121 and 122 may include a first internal electrode layer 121 and a second internal electrode layer 122, and the first and second internal electrode layers 121 and 122 may be alternately disposed in the first direction with the dielectric layer 111, included in the body 110, interposed therebetween. Hereinafter, unless otherwise inconsistent therewith, descriptions of the internal electrode layers 121 and 122 may correspond to descriptions of the first and second internal electrode layers 121 and 122, respectively.

The first internal electrode layer 121 may be connected to the third and fourth external electrodes 133 and 134, and the second internal electrode layer 122 may be connected to the first and second external electrodes 131 and 132.

More specifically, the first internal electrode layer 121 may include a first internal electrode layer 121a exposed to the fifth and sixth surfaces 5 and 6 to be connected to the third and fourth external electrodes 133 and 134, and a first dummy electrode layer 121b disposed to be spaced apart from the first internal electrode layer 121a. The second internal electrode layer 122 may include a second internal electrode layer 122a exposed to the third and fourth surfaces 3 and 4 to be connected to the first and second external electrodes 131 and 132.

The first internal electrode layer 121 may be described as follows in more detail.

The first internal electrode layer 121a may be spaced apart from third and fourth surfaces 3 and 4, and may be exposed to fifth and sixth surfaces 5 and 6 to be connected to the third and fourth external electrodes 133 and 134. The first dummy electrode layer 121b may be disposed to be spaced apart from the first internal electrode layer 121a.

The first internal electrode layer 121a may include a first main portion 121a-0 forming capacitance, and first lead portions 121a-1 and 121a-2 not forming capacitance, the first lead portions 121a-1 and 121a-2 exposed to the fifth and sixth surfaces 5 and 6. Specifically, the first lead portions 121a-1 and 121a-2 may include a first-first lead portion 121a-1 exposed to the fifth surface 5, and a first-second lead portion 121a-2 exposed to the sixth surface 6. Hereinafter, unless otherwise inconsistent therewith, descriptions of the first lead portions 121a-1 and 121a-2 may correspond to descriptions of the first-first and first-second lead portions 121a-1 and 121a-2, respectively.

More specifically, the first main portion 121a-0 may have a rectangular shape having a substantially constant size in the second direction and a substantially constant size in the third direction, and the first lead portions 121a-1 and 121a-2 may also have a rectangular shape having a substantially constant size in the second direction and a substantially constant size in the third direction. In this case, a size in the second direction or a size in the third direction of each of the first lead portions 121a-1 and 121a-2 may be smaller than a size in the second direction or a size in the third direction of the main portion 121a-0.

In the present disclosure, the substantially constant size in the second direction may mean that a difference (absolute value) between an average size in the second direction and a size in the second direction is 10% or less relative to the average size in the second direction, which may be equally applied to the substantially constant size in the third direction.

In addition, the first lead portions 121a-1 and 121a-2 may not form capacitance and may not overlap the second internal electrode layer 122a in the first direction. The first lead portions 121a-1 and 121a-2 may be exposed to the fifth and sixth surfaces 5 and 6 of the body, but may be disposed to be covered by the third and fourth external electrodes 133 and 134 to be described below, and thus may not be externally exposed. In other words, the first-first lead portion 121a-1 may be exposed to the fifth surface 5, but may be disposed to be entirely covered by the third external electrode 133, and thus may not be externally exposed. Similarly, the first-second lead portion 121a-2 may be exposed to the sixth surface 6, but may be disposed to be entirely covered by the fourth external electrode 134, and thus may not be externally exposed.

The first dummy electrode layer 121b may not form capacitance, and at least a portion of the first dummy electrode layer 121b may overlap the second internal electrode layer 122a in the first direction. The first dummy electrode layer 121b may serve to reduce a step portion caused by repeated stacking or to improve bending strength.

More specifically, the first dummy electrode layer 121b may include a first-first dummy electrode layer 121b-1 disposed between the first internal electrode layer 121a and the third surface 3, and a first-second dummy electrode layer 121b-2 disposed between the first internal electrode layer 121a and the fourth surface 4. In the drawings, it is illustrated that the first-first dummy electrode layer 121b-1 is exposed to the third surface 3 and is not exposed to the fifth and sixth surfaces 5 and 6, and the first-second dummy electrode layer 121b-2 is exposed to the fourth surface 4 and is not exposed to the fifth and sixth surfaces 5 and 6, but the present disclosure is not limited thereto. More specifically, the first-first dummy electrode layer 121b-1 may not be exposed to the third surface 3 and may be sufficiently disposed between the third surface 3 and the first internal electrode layer 121a, and may be exposed to at least one of the fifth and sixth surfaces 5 and 6. Similarly, the first-second dummy electrode layer 121b-2 may not be exposed to the fourth surface 4 and may be sufficiently disposed between the fourth surface 4 and the first internal electrode layer 121a, and may be exposed to at least one of the fifth and sixth surfaces 5 and 6.

In addition, when the first dummy electrode layer 121b is exposed to at least one surface of the body 110, the first dummy electrode layer 121b may be disposed to be covered by the first and second external electrodes 131 and 132. In other words, the first-first dummy electrode layer 121b-1 may be exposed to at least a portion of at least one of the third, fifth, and sixth surfaces 3, 5, and 6, but may be disposed to be entirely covered by the first external electrode 131 and thus may not be externally exposed. The first-second dummy electrode layer 121b-2 may be exposed to at least a portion of one or more of the fourth, fifth, and sixth surfaces 4, 5, and 6, but may be disposed to be entirely covered by the second external electrode 132, and thus may not be externally exposed.

The second internal electrode layer 122 may be described as follows in more detail.

The second internal electrode layer 122 may include a second internal electrode layer 122a exposed to the third and fourth surfaces 3 and 4 to be connected to the first and second external electrodes 131 and 132. The second internal electrode layer 122 may be preferably formed of the second internal electrode layer 122a. In other words, the second internal electrode layer 122 preferably may not include an electrode or metal material other than the second internal electrode layer 122a.

The second internal electrode layer 122a may be disposed to be spaced apart from the fifth and sixth surfaces 5, 6. The second internal electrode layer 122a may include a second main portion 122a-0 forming capacitance, and second lead portions 122a-1 and 122a-2 not forming capacitance and, the second lead portions 122a-1 and 122a-2 exposed to the third and fourth surfaces 3 and 4 to be connected to the first and second external electrodes 131 and 132. Specifically, the second lead portions 122a-1 and 122a-2 may include a second-first lead portion 122a-1 exposed to the fifth surface 5 to be connected to the first external electrode 131, and a second-second lead portion 122a-2 exposed to the sixth surface 6 to be connected to the second external electrode 132. Hereinafter, unless otherwise inconsistent therewith, descriptions of the second lead portions 122a-1 and 122a-2 may correspond to the descriptions of the second-first lead portion 122a-1 and the second-second lead portion 122a-2, respectively.

More specifically, the second internal electrode layer 122a may have a rectangular shape with a substantially constant size in the second direction and a substantially constant size in the third direction. That is, the second main portion 122a-0 may have a rectangular shape with a substantially constant size in the second direction and a substantially constant size in the third direction, and the second lead portions 122a-1 and 122a-2 may have a rectangular shape with a substantially constant size in the second direction and a substantially constant size in the third direction. The size in the third direction of the second lead portions 122a-1 and 122a-2 and the size in the third direction of the second main portion 122a-0 may be substantially constant.

The first and second internal electrode layers 121 and 122 may be electrically isolated from each other by the dielectric layer 111 interposed therebetween.

The body 110 may be formed by alternately stacking a first ceramic green sheet on which a first internal electrode layer paste, which will be the first internal electrode layer 121, is printed and a second ceramic green sheet on which a second internal electrode layer paste, which will be the second internal electrode layer 122, is printed and then performing sintering thereon.

A material included in the internal electrode layers 121 and 122 is not limited, and a material having excellent electrical conductivity may be used. For example, the internal electrode layers 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrode layers 121 and 122 may be formed by printing, on a ceramic green sheet, a conductive paste for internal electrode layers including at least one of nickel (Ni), copper (Cu), palladium (Pd), silver (Ag), gold (Au), platinum (Pt), tin (Sn), tungsten (W), titanium (Ti), and alloys thereof. A screen-printing method or a gravure-printing method may be used as a method of printing the conductive paste for internal electrode layers, but the present disclosure is not limited thereto.

A length in the first direction (te) of each of the internal electrode layers 121 and 122 is not limited. Hereinafter, the length in the first direction (te) of each of the internal electrode layers 121 and 122 may refer to a length in the first direction (te) of each of the first internal electrode layer 121 and the second internal electrode layer 122.

In order to achieve miniaturization and high capacitance of the multilayer electronic component 100, the length in the first direction (te) of each of the internal electrode layers 121 and 122 may be 1.0 μm or less. In order to more easily achieve ultra-miniaturization and high capacitance, the length in the first direction (te) of each of the internal electrode layers 121 and 122 may be 0.8 μm or less or 0.6 μm or less, and more preferably 0.4 μm or less.

The length in the first direction (te) of each of the internal electrode layers 121 and 122 may be based on a concept including a length in the first direction (te) of at least one of a plurality of internal electrode layers 121 and 122, or may be based on a concept including lengths (te) in the first direction of all the internal electrode layers 121 and 122.

The length in the first direction (te) of each of the internal electrode layers 121 and 122 may be based on a concept including a length in the first direction (te) of at least one of a plurality of internal electrode layers 121 and 122, or may be based on a concept including lengths (te) of all the internal electrode layers 121 and 122.

In addition, the length in the first direction (te) of each of the internal electrode layers 121 and 122 may refer to an average length in the first direction (te) of each of the internal electrode layers 121 and 122, may refer to an average length in the first direction (te) of each of the plurality of internal electrode layers 121 and 122, or may refer to average lengths (te) of the plurality of internal electrode layers 121 and 122.

The average length in the first direction (te) of each of the internal electrode layers 121 and 122 may be measured by scanning, with an SEM, an image of a cross-section of the body 110 in the first and second directions at a magnification of 10,000. More specifically, the average length in the first direction (te) of each of the internal electrode layers 121 and 122 may be an average value of lengths of each of the internal electrode layers 121 and 122, measured at five points spaced apart from each other at equal intervals in the second direction, in the scanned image. The five points, spaced apart from each other at equal intervals, may be designated in the capacitance formation portion Ac. In addition, when such average value measurement is performed on three internal electrode layers 121 and 122, the average lengths (te) of the plurality of internal electrode layers 121 and 122 may be further generalized.

The body 110 may include cover portions 112 and 113 disposed on both end surfaces (or both surfaces) in the first direction of the capacitance formation portion Ac.

Specifically, the cover portions 112 and 113 may include a first cover portion 112 disposed on one surface in the first direction of the capacitance formation portion Ac, and a second cover portion 113 disposed on the other surface in the second direction of the capacitance formation portion Ac. More specifically, for example, the cover portions 112 and 113 may include the first cover portion 112 disposed on a lower portion in the first direction of the capacitance formation portion Ac, and the second cover portion 113 disposed on an upper portion in the first direction of the capacitance formation portion Ac.

The cover portions 112 and 113 may be formed by disposing, respectively, a single second dielectric layer or two or more second dielectric layers on upper and lower surfaces of the capacitance formation portion Ac in the first direction, or by stacking the second dielectric layers in the first direction, and may basically serve to prevent damage to the internal electrode layers 121 and 122 caused by physical or chemical stress.

The first cover portion 112 and the second cover portion 113 may not include the internal electrode layers 121 and 122, and may include a dielectric material the same as that of the first dielectric layer 111 of the capacitance formation portion Ac. In addition, the material of the first cover portion 112 and the second cover portion 113 may be the same as that of the first dielectric layer 111. That is, the first cover portion 112 and the second cover portion 113 may include a dielectric material, and for example, may include a barium titanate (BaTiO₃)-based dielectric material.

A length in the first direction (tc) of each of the cover portions 112 and 113 is not limited. Hereinafter, the length in the first direction (tc) of each of the cover portions 112 and 113 may refer to a length in the first direction (tc) of each of the first cover portion 112 and the second cover portion 113.

However, in order to more easily achieve miniaturization and high capacitance of the multilayer electronic component 100, the length in the first direction (tc) of each of the cover portions 112 and 113 may be 100 μm or less, or 50 μm or less, preferably 30 μm or less, and more preferably 20 μm or less in ultra-small products. In addition, the length in the first direction (tc) of each of the cover portions 112 and 113 may be 20 μm or more, 15 μm or more, 10 μm or more, or 5 μm or more.

In an example embodiment of the present disclosure, at least one of the first and second cover portions 112 and 113 may have, at least partially, a concave shape in an inward direction of the body 110, and both the first and second cover portions 112 and 113 may preferably have, at least partially, a concave shape in the inward direction of the body 110. In this case, external surfaces of the first and second cover portions 112 and 113 may have a concave shape. Here, the external surfaces may refer to the first and second surfaces 1 and 2.

The length in the first direction (tc) of each of the cover portions 112 and 113 may refer to a length in the first direction (tc) of each of the first and second cover portions 112 and 113.

In this case, each of the cover portions 112 and 113 may have a length in the first direction (tc) that is not substantially constant over the entire region. For example, based on a cross-section in the first and second directions of each of the cover portions 112 and 113, the length in the first direction (tc) that is not substantially constant over the entire region may mean that the length in the first direction (tc) over the entire region satisfies 100 μm or less, but may not mean that the length in the first direction (tc) is substantially constant. As another example, based on a cross-section in the first and third directions of each of the cover portions 212 and 213, the length in the first direction (tc) that is not substantially constant over the entire region may mean that a length in the first direction (tc′) of a central portion in the third direction of each of the cover portions 212 and 213 satisfies 100 μm or less, and a length in the first direction (t″) of each of both end portions in the third direction of each of the cover portions 212 and 213 also satisfies 100 μm or less.

In addition, the cover portions 112 and 113 may include, at least partially, a region having a length in the first direction that decreases from both end portions in the second direction of each of the cover portions 112 and 113 toward a central portion in the second direction of each of the cover portions 112 and 113.

The length in the first direction (tc) of each of the cover portions 112 and 113 may be measured by scanning, with an SEM, an image of a cross-section of the body 110 in the first and second directions at a magnification of 10,000. More specifically, the length in the first direction may be obtained by measuring lengths in the first direction while moving in the second direction in a scanned image of a single cover portion.

The multilayer electronic component 100 may include side margin regions 114′ and 115′, end regions in the third direction of the internal electrode layers 121 and 122.

More specifically, the side margin regions 114′ and 115′ may include a first side margin region 114′ disposed between the internal electrode layers 121 and 122 and the fifth surface 5, and a second side margin region 115′ disposed between the internal electrode layers 121 and 122 and the sixth surface 6.

As illustrated, the side margin regions 114′ and 115′ may refer to regions between both ends in the third direction of each of the first and second internal electrode layers 121 and 122 and a boundary surface of the body 110, based on a cross-section of the body 110 in the first and third directions.

The side margin regions 114′ and 115′ may refer to regions of a ceramic green sheet for the capacitance formation portion Ac, other than the internal electrode layers 121 and 122, when a conductive paste for internal electrode layers is applied to the ceramic green sheet excluding regions in which the side margin regions 114′ and 115′ are to be formed.

The side margin regions 114′ and 115′ may serve to prevent damage to the internal electrode layers 121 and 122 caused by physical or chemical stress.

The first side margin region 114′ and the second side margin region 115′ may not include the internal electrode layers 121 and 122, may include a material the same as that of the first dielectric layer 111, and, for example, may correspond to a portion of the first dielectric layer 111. That is, the first side margin region 114′ and the second side margin region 115′ may include a dielectric material, and, for example, may include a barium titanate (BaTiO₃)-based dielectric material.

A length in the third direction (wm′) of each of the side margin regions 114′ and 115′ is not limited. Hereinafter, the length in the third direction (wm′) of each of the side margin regions 114′ and 115′ may refer to a length in the third direction (wm′) of each of the first side margin region 114′ and the second side margin region 115′.

In order to more easily achieve miniaturization and high capacitance of the multilayer electronic component 100, the length in the third direction (wm′) of each of the side margin regions 114′ and 115′ may be 50 μm or less, preferably 30 μm or less, and more preferably 20 μm or less for ultra-small products.

In addition, the length in the third direction (wm′) of each of the side margin regions 114′ and 115′ may refer to an average length in the third direction (wm′) of each of the first and second side margin regions 114′ and 115′, or may refer to average lengths in the third direction (wm′) of the first and second side margin regions 114′ and 115′.

The average length in the third direction (wm′) of each of the side margin portions 114′ and 115′ may be measured by scanning, with an SEM, an image of a cross-section in the first and third directions of the body 110 at a magnification of 10,000. More specifically, the average length in the third direction (wm′) of each of the side margin portions 114′ and 115′ may refer to an average value of lengths of one of the side margin portions 114′ and 115′, measured at five points spaced apart from each other at equal intervals in the first direction, in the scanned image.

In an example embodiment of the present disclosure, a structure in which the multilayer electronic component 100 has four external electrodes 131, 132, 133, and 134, the number, shape, or the like of the external electrodes 131, 132, 133, and 134 may vary depending on a form of the internal electrode layers 121 and 122 or other purposes.

The external electrodes 131, 132, 133, and 134 may include first and second external electrodes 131 and 132 respectively disposed on the third and fourth surfaces 3 and 4, and third and fourth external electrodes 133 and 134 respectively disposed on the fifth and sixth surfaces 5 and 6, and the first to fourth external electrodes 131, 132, 133, and 134 may be disposed to be spaced apart from each other.

In addition, the first and second external electrodes 131 and 132 may be disposed to extend to portions of first and second surfaces 1 and 2, and may be disposed to extend to portions of fifth and sixth surfaces 5 and 6 of the body 110. In addition, the third and fourth external electrodes 133 and 134 may be disposed to extend to portions of the first and second surfaces 1 and 2.

That is, the first external electrode 131 may be disposed on the third surface 3 and may be disposed to extend to portions of the first, second, fifth, and sixth surfaces 1, 2, 5, and 6, the second external electrode 132 may be disposed on the fourth surface 4 and may be disposed to extend to portions of the first, second, fifth, and sixth surfaces 1, 2, 5, and 6, the third external electrode 133 may be disposed on (preferably, on a portion of) the fifth surface 5 and may be disposed to extend to portions of the first and second surfaces 1 and 2, and the fourth external electrode 134 may be disposed on (preferably, on a portion of) the sixth surface 6 and may be disposed to extend to portions of the first and second surfaces 1 and 2.

The first and second external electrodes 131 and 132 may be connected to the second internal electrode layer 122, and the third and fourth external electrodes 133 and 134 may be connected to the first internal electrode layer 121. In this case, the first and second external electrodes 131 and 132 may be connected to at least one of first-first and first-second dummy electrodes 121b-1 and 121b-2 of the first internal electrode layer 121. However, even in this case, the first and second external electrodes 131 and 132 may not be connected to the first main portion 121a-0.

As described above, a body may include a ceramic material, and accordingly, a step portion may be formed when a multilayer electronic component, including external electrodes formed thereon, is mounted on a board, due to shrinkage of ceramic particles during a sintering process. Alternatively, as internal electrodes (layers) having different shapes are repeatedly stacked, the body may have a step portion. As a result, when the multilayer electronic component, including external electrodes formed thereon, is mounted on the board, a step portion may also be formed. A step portion during mounting may cause mounting defects and more easily induce defects in the component. Accordingly, minimizing a step portion during mounting to improve planarity of the body during mounting may also be one of the important challenges.

Accordingly, in the multilayer electronic component 100 according to an example embodiment of the present disclosure, when the multilayer electronic component 100 is observed in the third direction, a length in the first direction (T1) of each of both end portions in the second direction of the body 110 may be greater than a length in the first direction (T2) of a central portion of the body 110 in the second direction (T2<T1), a maximum length in the first direction of each of regions of the third and fourth external electrodes 133 and 134, disposed to extend to a portion of the first surface 1, may be greater than a maximum length in the first direction of each of regions of the first and second external electrodes 131 and 132, disposed to extend to a portion of the first surface 1, a maximum length in the first direction (ET2) of each of regions of the third and fourth external electrodes 133 and 134, disposed to extend to a portion of the second surface 2, may be greater than a maximum length in the first direction (ET1) of each of regions of the first and second external electrodes 131 and 132, disposed to extend to a portion of the second surface 2 (ET1<ET2), and both ends in the first direction (ELT2) of each of the third and fourth external electrodes 133 and 134 may not exceed both ends in the first direction (ELT1) of each of the first and second external electrodes 131 and 132.

In the present disclosure, observing the multilayer electronic component 100 in the third direction may mean observing an exterior of the multilayer electronic component 100 toward the fifth surface 5 or the sixth surface 6, including the first to fourth external electrodes 131, 132, 133, and 134.

The length in the first direction (T1) of each of both end portions in the second direction of the body 110 may refer to a length in the first direction of the body 110, measured at one end in the second direction of the first or second external electrode 131 or 132.

Specifically, referring to FIG. 2, in which the multilayer electronic component 100 is observed toward the sixth surface 6, the length in the first direction (T1) of each of both end portions in the second direction of the body 110 may refer to a length in the first direction of the body 110, measured at an outermost end portion (maximum point) of each of the first and second external electrodes 131 and 132 positioned to be adjacent to the fourth external electrode 134. More specifically, a length in the first direction of one end portion in the second direction of the body 110, measured at one end (maximum point) of the second external electrode 132 adjacent to the fourth external electrode 134, may be referred to as T1.

Using the above-described method, a length in the first direction of the other end portion in the second direction of the body 110 may be measured and obtained at one end (maximum point) in the second direction of the first external electrode, adjacent to the fourth external electrode 134. A case in which the multilayer electronic component 100 is observed toward the sixth surface 6 is described as an example. However, even when the multilayer electronic component 100 is observed toward the fifth surface 5, it will be apparent to those skilled in the art that the length in the first direction (T1) of each of both end portions in the second direction of the body 110 may be obtained using the above-described method.

Hereinafter, unless otherwise inconsistent therewith, the length in the first direction (T1) of each of both end portions in the second direction of the body 110 may refer to a length in the first direction of the body 110, measured at one end (maximum point) in the second direction of the first external electrode 131, and a length in the first direction (T1) of the body 110, measured at one end (maximum point) in the second direction of the second external electrode 132.

The length in the first direction (T2) of the central portion in the second direction of the body 110 may refer to a length in the first direction of the body 110, measured at one end (maximum point) or the other end (maximum point) in the second direction of the third or fourth external electrodes 133 and 134.

Specifically, referring to FIG. 2, in which the multilayer electronic component 100 is observed toward the sixth surface 6, the length in the first direction (T2) of the central portion in the second direction of the body 110 may refer to a smaller value, among values of lengths in the first direction of the body 110, measured at an outermost end (maximum point) of the fourth external electrode 134 positioned to be adjacent to the first external electrode 131 or the second external electrode. More specifically, a smaller value, among a value of a length in the first direction of the body 110, measured at one end (maximum point) in the second direction of the fourth external electrode 134 adjacent to the first external electrode 131, and a value of a length in the first direction of the body 110, measured at the other end (maximum point) in the second direction of the fourth external electrode 134 adjacent to the second external electrode 132, may be referred to as T2. For ease of description, only a case in which the multilayer electronic component 100 is observed toward the sixth surface 6 has been described, but it will be apparent to those skilled in the art that the above description may be equally applied to even a case in which the multilayer electronic component 100 is observed toward the fifth surface 5, which is the other surface observed in the third direction.

The length in the first direction (T1) of each of both end portions in the second direction of the body 110 greater than the length in the first direction (T2) of the central portion in the second direction of the body 110 may mean that at least one of the first and second surfaces 1 and 2, at least partially, having a concave shape in an inward direction of the body 110, and preferably, the first and second surfaces 1 and 2, at least partially, having a concave shape in the inward direction of the body 110.

In addition, at least one of the first and second surfaces 1 and 2 may have a curvature (κ) in the inward direction of the body 110, and preferably, the first and second surfaces 1 and 2 may have a curvature (κ) in the inward direction of the body 110.

More specifically, for example, a curvature (κ) of at least one of the first and second surfaces 1 and 2 in the inward direction of the body 110 of may be greater than 0.0 mm and less than or equal to 1.0 mm. In other words, at least one of the first and second surfaces 1 and 2 may have a curvature (κ) satisfying 0.0 mm<κ≤1.0 mm, which may mean that a curvature value of the first surface 1 is greater than 0.0 mm and less than or equal to 1.0 mm, or that a curvature value of the second surface 2 may be greater than 0.0 mm and less than or equal to 1.0 mm.

In addition, the body 110 may include, at least partially, a region having a length in the first direction that decreases from the both end portions in the second direction toward the central portion in the second direction.

A method of measuring a maximum length in the first direction (ET2) of each of regions of the third and fourth external electrodes 133 and 134, disposed to extend to portions of the first and second surfaces 1 and 2, and a maximum length in the first direction (ET1) of each of regions of the first and second external electrodes 131 and 132, disposed to extend to portions of the first and second surfaces 1 and 2, will be described as follow, but the present disclosure is not limited thereto.

First, a method of measuring the maximum length in the first direction (ET2) of each of the regions of the third and fourth external electrodes 133 and 134, disposed to extend to portions of the first and second surfaces 1 and 2, will be described in detail with reference to FIG. 2, in which the multilayer electronic component 100 is observed toward the sixth surface 6. In a region of the fourth external electrode 134, disposed to extend to a portion of the second surface 2, a length in the first direction of the fourth external electrode 134, measured from the second surface 2, may be referred to as ET2. Here, the maximum length in the first direction (ET2) of the fourth external electrode 134, measured from the second surface 2, may be referred to as a maximum length in the first direction of the fourth external electrode 134, measured from one point adjacent to the first external electrode 131, among points at which the fourth external electrode 134 and the second surface 2 are in contact with each other, and a maximum length in the first direction of the fourth external electrode 134, measured from the other point adjacent to the second external electrode 132.

Using the above-described method, a maximum length in the first direction of a region of the fourth external electrode 134, disposed to extend to a portion of the first surface 1, may be obtained. Similarly, when the multilayer electronic component 100 is observed toward the fifth surface 5, which is a surface observed in a direction different from the third direction, that is, it will be obvious to those skilled in the art that a maximum length in the first direction of a region of the third external electrode 133, disposed to extend to a portion of the first surface 1, and a maximum length in the first direction of a region of the third external electrode 133, disposed to extend to a portion of the second surface 2, may be obtained using the above-described method.

Subsequently, a method of measuring the maximum length in the first direction (ET1) of each of regions of the first and second external electrodes 131 and 132, disposed to extend to portions of the first and second surfaces 1 and 2, is described in detail with reference to FIG. 2, in which the multilayer electronic component 100 is observed toward the sixth surface 6. In a region of the second external electrode 132 disposed to extend to a portion of the second surface 2, a maximum length in the first direction of the second external electrode 132, measured from the second surface 2, may be referred to as ET1. Here, the maximum length in the second direction (ET2) of the second external electrode 132, measured from the second surface 2, may be referred to as a maximum length in the first direction of the second external electrode 132, measured from a point at which the second external electrode 132 and the second surface 2 are in contact with each other.

Using the above-described method, a maximum length in the first direction of a region of the second external electrode 132, disposed to extend to a portion of the first surface 1, may be obtained, and a maximum length in the first length of a region of the first external electrode 131, disposed to extend to a portion of the first surface 1 or the second surface 2, may be obtained. Similarly, when the multilayer electronic component 100 is observed toward the fifth surface 5, which is a surface observed in a direction different from the third direction, that is, it will be obvious to those skilled in the art that a maximum length in the first direction of a region of the third external electrode 133, disposed to extend to a portion of the first surface 1, and a maximum length in the first direction of a region of the third external electrode 133, disposed to extend to a portion of the second surface 2, may be obtained using the above-described method.

In addition, a maximum length in the first direction (T2) of each of regions of the third and fourth external electrodes 133 and 134, disposed to extend to a portion of the first surface 1, greater than a maximum length in the first direction (T1) of each of the regions of the first and second external electrodes 131 and 132, disposed to extend to a portion of the first surface 1, may mean that a maximum length in the first direction of a region of the third external electrode 133, disposed to extend to a portion of the first surface 1, is greater than a maximum length in the first direction of a region of the first external electrode 131, disposed to extend to a portion of the first surface 1, and a maximum length in the first direction of a region of the second external electrode 132, disposed to extend to a portion of the first surface 1, and that a maximum length in the first direction of a region of the fourth external electrode 134, disposed to extend to a portion of the first surface 1, is greater than a maximum length in the first direction of a region of the first external electrode 131, disposed to extend to a portion of the first surface 1, and a maximum length in the first direction of a region of the second external electrode 132, disposed to extend to a portion of the first surface 1.

Similarly, the maximum length in the first direction (T2) of each of the regions of the third and fourth external electrodes 133 and 134, disposed to extend to a portion of the second surface 2, greater than the maximum length in the first direction (T1) of each of the regions of the first and second external electrodes 131 and 132, disposed to extend to a portion of the second surface 2, may mean that a maximum length in the first direction of the region of the third external electrode 133, disposed to extend to a portion of the second surface 2, is greater than a maximum length in the first direction of a region of the first external electrode 131, disposed to extend to a portion of the second surface 2, and a maximum length in the first direction of a region of the second external electrode 132, disposed to extend to a portion of the second surface 2, and that a maximum length in the first direction of the region of the fourth external electrode 134, disposed to extend to a portion of the second surface 2, is greater than a maximum length in the first direction of a region of the first external electrode 131, disposed to extend to a portion of the second surface 2, and a maximum length in the first direction of a region of the second external electrode 132, disposed to extend to a portion of the second surface 2.

Subsequently, both ends in the first direction (ELT2) of each of the third and fourth external electrodes 133 and 134 not exceeding both ends in the first direction (ELT1) of each of the first and second external electrodes 131 and 132 may mean that, when a straight line drawn to be substantially parallel to the second direction from both ends in the first direction of each of the third and fourth external electrodes 133 and 134 is referred to as ELT2, and a straight line drawn to be substantially parallel to the second direction from both ends in the first direction of each of the first and second external electrodes 131 and 132 is referred to as ELT1, ELT2 does not exceed ELT1 in an outward direction of the body, and a difference (ST) between ELT1 and ELT2, measured from the same point on one surface of the body, is 0 or more (0≤ST).

The difference (ST) between ELT1 and ELT2, measured from the same point on the one surface of the body, may be most preferably zero, and may be preferably closer to zero. An upper limit value thereof is not limited, but may be 50 μm or less, 40 μm or less, 30 μm or less, 20 μm or less, or 10 μm or less.

The difference (ST) between ELT1 and ELT2, measured from the same point on the one side of the body, may satisfy 0 or more (0≤ST). Thus, when mounted on a board, a constant amount of solder may be applied to a space between the first to fourth external electrodes 131, 132, 133, and 134 and a mounting surface, thereby improving a mounting rate of the multilayer electronic component 100, and achieving planarity during mounting to effectively prevent defects in the multilayer electronic component 100.

In addition, both ends in the first direction (ELT2) of each of the third and fourth external electrodes 133 and 134 not exceeding both ends in the first direction (ELT1) of each of the first and second external electrodes 131 and 132 may mean that one-direction end in the first direction of the third external electrode 133 does not exceed one-direction end in the first direction of the first external electrode 131 and one-direction end in the first direction of the second external electrode 132, that the other-direction end in the first direction of the third external electrode 133 does not exceed the other-direction end in the first direction of the first external electrode 131 and the other-direction end in the first direction of the second external electrode 132, that one-direction end in the first direction of the fourth external electrode 134 does not exceed one-direction end in the first direction of the first external electrode 131 and one-direction end in the first direction of the second external electrode 132, and that the other-direction end in the first direction of the fourth external electrode 133 does not exceed the other-direction end in the first direction of the first external electrode 131 and the second-direction-direction end of the second external electrode 132.

In an example embodiment of the present disclosure, a length in the first direction (T1) of each of both end portions in the second direction of the body 110 may be greater than a length in the first direction (T2) of a central portion in the second direction of the body 110 (T2<T1), a maximum length in the first direction of each of regions of the third and fourth external electrodes 133 and 134, disposed to extend to a portion of the first surface, may be greater than a maximum length in the first direction of each of regions of the first and second external electrodes 131 and 132, disposed to extend to a portion of the first surface 1, a maximum length in the first direction (ET2) of each of regions of the third and fourth external electrodes 133 and 134, disposed to extend to a portion of the second surface 2, may be greater than a maximum length in the first direction (ET1) of each of regions of the first and second external electrodes 131 and 132, disposed to extend to a portion of the second surface 2 (ET1<ET2), and both ends in the first direction (ELT2) of each of the third and fourth external electrodes 133 and 134 may not exceed both ends (ELT1) of each of the first and second external electrodes 131 and 132, thereby minimizing a step portion formed when the multilayer electronic component 100, including the external electrodes 131, 132, 133, and 134 formed thereon, is mounted on a board. Accordingly, a mounting rate may be improved and mounting defects may be more effectively prevented from occurring.

In addition, when a cross-section in the first and second directions of at least one of both end portions in the third direction of the multilayer electronic component 200 is observed to include the body 210 and the first to fourth external electrodes 231, 232, 233, and 234, a length in the first direction (T1) of each of both end portions in the second direction of the body 210 may be greater than a length in the first direction (T2) of a central portion in the second direction of the body 210 (T2<T1), a maximum length in the first direction of each of regions of the third and fourth external electrodes 233 and 234, disposed to extend to a portion the first surface 1, may be greater than a maximum length in the first direction of each of regions of the first and second external electrodes 231 and 232, disposed to extend to a portion of the first surface 1, a maximum length in the first direction (ET2) of each of regions of the third and fourth external electrodes 233 and 234, disposed to extend to a portion of the second surface 2, may be greater than a maximum length in the first direction (ET1) of each of regions of the first and second external electrodes 231 and 232, disposed to extend to a portion of the second surface 2, and both ends in the first direction (ELT2) of each of the third and fourth external electrodes 233 and 234 may not exceed both ends in the first direction (ELT1) of each of the first and second external electrodes 231 and 232.

Here, one end portion, among both end portions in the third direction of the multilayer electronic component 200, may refer to a region including the first, second, and fourth external electrodes 231, 232, and 234, and the other end portion may refer to a region including the first to third external electrodes 231, 232, and 233.

Except for a case in which a cross-section in the first and second directions of at least one of both end portions in the third direction of the multilayer electronic component 200 were observed to include the body 210 and the first to fourth external electrodes 231, 232, 233, and 234, an observation result of the multilayer electronic component 200 in the third direction may be substantially the same as that of the multilayer electronic component 100 observed in the third direction, and thus a detailed description thereof will be omitted. In addition, although the above description has been provided based on the multilayer electronic component 200 according to another example embodiment, it will be apparent to those skilled in the art that, unless otherwise inconsistent therewith, the above description may be equally applied to the multilayer electronic component 100 according to the example embodiment.

An average length in the first direction of each of regions of the third and fourth external electrodes 133 and 134, disposed to extend to a portion of the first surface 1, may be greater than an average length in the first direction of each of regions of the first and second external electrodes 131 and 132, disposed to extend to a portion of the first surface 1, and an average length in the first direction of each of regions of the third and fourth external electrodes 133 and 134, disposed to extend to a portion of the second surface 2, may be greater than an average length in the first direction of each of regions of the first and second external electrodes 131 and 132, disposed to extend to a portion of the second surface 2.

Here, a method of obtaining an average length in the first direction of each of regions of the first to fourth external electrodes 131, 132, 133, and 134, disposed to extend to portions of the first and second surfaces 1 and 2, may be described as follows, but the present disclosure is not limited thereto, and the description may be equally applied to the multilayer electronic component 200 according to another example embodiment of the present disclosure. First, when a cross-section in the first and second directions of at least one of both end portions in the third direction of the multilayer electronic component 100 is observed with an SEM, a transmission electron microscope (TEM), a scanning electron microscope (STEM), or the like so as to include the body 110 and the first to fourth external electrodes 131, 132, 133, and 134, an average value of a length in the first direction of a central portion in the second direction of each of regions of the first to fourth external electrodes 131, 132, 133, and 134, disposed to extend to portions of the first and second surfaces 1 and 2, and lengths in the first direction at points spaced apart from the central portion in the second direction at equal intervals in opposite directions may be referred to as an average length in the first direction of each of regions of the first to fourth external electrodes 131, 132, 133, and 134, disposed to extend to portions of the first and second surfaces 1 and 2.

More specifically, when the cross-section in the first and second directions is observed with an SEM, a TEM, an STEM, or the like so as to include the body 110, which is one end portion in the third direction of the multilayer electronic component 100, and the first, second, and fourth external electrodes 131, 132, and 134, an average value of a length in the first direction of a central portion in the second direction of a region of the fourth external electrode 134, disposed to extend to a portion of the second surface 2, and lengths in the first direction of the fourth external electrode 134 at points spaced apart from the central portion in the second direction at equal intervals in opposite directions may be referred to as an average length in the first direction of a region of the fourth external electrode 134, disposed to extend to a portion of the second surface 2.

Using the above-described method, an average length in the first direction of a region of the fourth external electrode 134, disposed to extend to a portion of the first surface 1, may be obtained, and an average length in the first direction of each of regions of the first and second external electrodes 131 and 132, disposed to extend to a portion of the first surface 1, and an average length in the first direction of each of regions of the first and second external electrodes 131 and 132, disposed to extend to a portion of the second surface 2, may be obtained. Similarly, it will be apparent to those skilled in the art that an average length of each of regions of the first to third external electrodes 131, 132, and 133, disposed to extend to a portion of the first surface 1, and an average length of each of regions of the first to third external electrodes 131, 132, and 133, disposed to extend to a portion of the second surface 2 may be obtained by observing the cross-section in the first and second directions with an SEM, a TEM, an STEM, or the like so as to include the body 110, which is the other end portion in the third direction of the multilayer electronic component 100, and the first, second and third external electrodes 131, 132, and 133.

The above description may also be equally applied to various types of multilayer electronic components, including the multilayer electronic component 200 according to another example embodiment of the present disclosure.

An average length in the first direction of each of regions of the third and fourth external electrodes 133 and 134, disposed to extend to a portion of the first surface 1, may be greater than an average length in the first direction of each of regions of the first and second external electrodes 131 and 132, disposed to extend to a portion of the first surface 1, and an average length in the first direction of each of regions of the third and fourth external electrodes 133 and 134, disposed to extend to a portion of the second surface 2, may be greater than an average length in the first direction of each of regions of the first and second external electrodes 131 and 132, disposed to extend to a portion of the second surface 2, thereby minimizing step portion formed when the multilayer electronic component 100, including the external electrodes 131, 132, 133, and 134 formed thereon, is mounted on a board. Accordingly, a mounting rate may be improved and mounting defects may be more effectively prevented from occurring.

The external electrodes 131 and 132 may be formed of any material having electrical conductivity, such as a metal or the like, and a specific material may be determined in consideration of electrical properties, structural stability, or the like. In addition, the external electrodes 131 and 132 may have a multilayer structure.

For example, the external electrodes 131, 132, 133, and 134 may include first electrode layers 131a, 132a, 133a, and 134a disposed on the body 110, and second electrode layers 131b, 132b, 133b, and 134b disposed on the first electrode layers 131a, 132a, 133a, and 134a.

Here, the first and second electrode layers 131a, 132a, 131b, and 132b may preferably correspond to mutually distinct layers. However, the present disclosure is not limited thereto. The classification into the first and second electrode layers 131a, 132a, 131b, and 132b may merely reflect the order of manufacturing processes. The first and second electrode layers 131a, 132a, 131b, and 132b may not be distinguishable from each other and may be observed as a single layer.

In the present disclosure, the term “distinct” may refer to two layers being distinguishable due to a physical difference, a chemical difference, and/or a simple optical difference. The present disclosure is not limited thereto. However, the distinction between layers may be determined based on the presence or absence of an “interface.” The interface may refer to a surface at which two layers in contact with each other are distinguishable, and, for example, may refer to a surface at which the two layers are distinguishable due to a component difference observed through EDS analysis using equipment such as an SEM.

The first electrode layers 131a, 132a, 133a, and 134a may be formed by transferring a sheet including a conductive metal onto the body 110, or by applying a conductive paste for external electrodes including a conductive metal to the body 110 and then sintering the conductive paste. Alternatively, the first electrode layers 131a, 132a, 133a, and 134a may be formed by a dipping method in which the body 110 is immersed in the conductive paste for external electrodes including a conductive metal. However, the present disclosure is not limited thereto.

As a more specific example of the first electrode layers 131a, 132a, 133a, and 134a, the first electrode layers 131a, 132a, 133a, and 134a may be sintered electrodes including a conductive metal and glass.

As the conductive metal included in the first electrode layers 131a, 132a, 133a, and 134a, a material having excellent electrical conductivity may be used. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof, but the present disclosure is not limited thereto.

The glass included in the first electrode layers 131a, 132a, 133a, and 134a may serve to improve adhesion to the body 110.

The second electrode layers 131b, 132b, 133b, and 134b may serve to improve mounting properties, and may be plating layers formed on the first electrode layers 131a, 132a, 133a, and 134a using a plating method, but the present disclosure is not limited thereto.

The types of the second electrode layers 131b, 132b, 133b, and 134b are not limited, and, for example, may include at least one selected from nickel (Ni), tin (Sn), silver (Ag), palladium (Pd), and alloys thereof.

The second electrode layers 131b, 132b, 133b, and 134b may be a single layer or a plurality of layers.

More specifically, for example, the second electrode layers 131b, 132b, 133b, and 134b may be a nickel (Ni) electrode layer or a tin (Sn) electrode layer, and may have a structure in which a nickel (Ni) electrode layer and a tin (Sn) electrode layer are sequentially formed on the first electrode layers 131a, 132a, 133a, and 134a, or a structure in which a tin (Sn) electrode layer, a nickel (Ni) electrode layer, and a tin (Sn) electrode layer are sequentially formed. In addition, the second electrode layers 131b, 132b, 133b, and 134b may include a plurality of nickel (Ni) electrode layers and/or a plurality of tin (Sn) electrode layers.

A size of the multilayer electronic component 100 is not limited.

However, to simultaneously achieve miniaturization and high capacitance, a dielectric layer and an internal electrode may need to have a reduced length in the first direction to increase the number of stacked layers. Thus, the multilayer electronic component 100 having a size of 2012 (length in the second direction×length in the second direction: 2.0 mm×1.2 mm, with a tolerance of ±10% for length in the second direction and length in the second direction) or less may exhibit more significant effects according to the present disclosure.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein is for the purpose of describing particular example embodiments only and is not to be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer, a first internal electrode layer, and a second internal electrode layer alternately disposed in a first direction with the dielectric layer interposed therebetween, the body having a first surface and a second surface opposing each other in the first direction, a third surface and a fourth surface connected to the first surface and the second surface, the third surface and the fourth surface opposing each other in a second direction, and a fifth surface and a sixth surface connected to the first surface, the second surface, the third surface, and the fourth surface, the fifth surface and the sixth surface opposing each other in a third direction;
a first external electrode and a second external electrode respectively disposed on the third surface and the fourth surface, the first external electrode and the second external electrode configured to extend to first portions of the first surface and the second surface; and
a third external electrode and a fourth external electrode respectively disposed on the fifth surface and the sixth surface, the third external electrode and the fourth external electrode configured to extend to second portions of the first surface and the second surface,
wherein, on a plane perpendicular to the third direction,
a length in the first direction of each of both end portions in the second direction of the body is greater than a length in the first direction of a central portion in the second direction of the body:
a first maximum length in the first direction of each of regions of the third electrode and the fourth external electrode, configured to extend to a portion of the first surface, is greater than a second maximum length in the first direction of each of regions of the first external electrode and the second external electrode, configured to extend to a portion of the first surface,
a third maximum length in the first direction of each of regions of the third electrode and the fourth external electrode, configured to extend to a portion of the second surface, is greater than a fourth maximum length in the first direction of each of regions of the first external electrode and second external electrode, configured to extend to a portion of the second surface, and
both ends in the first direction of each of the third electrode and the fourth external electrode do not exceed both ends in the first direction of each of the first electrode and the second external electrode.

2. The multilayer electronic component of claim 1, wherein
a first average length in the first direction of each of the regions of the third external electrode and the fourth external electrode, configured to extend to a third portion of the first surface, is greater than a second average length in the first direction of each of the regions of the first external electrode and the second external electrode, disposed to extend to the third portion of the first surface, and
a third average length in the first direction of each of the regions of the third external electrode and the fourth external electrode, configured to extend to a fourth portion of the second surface, is greater than a fourth average length in the first direction of each of the regions of the first external electrode and the second external electrode, configured to extend to the fourth portion of the second surface.

3. The multilayer electronic component of claim 1, wherein:
the first internal electrode layer includes a first internal electrode exposed to the fifth surface and the sixth surface to be connected to the third external electrode and the fourth external electrode, and a first dummy electrode disposed to be spaced apart from the first internal electrode, and
the second internal electrode layer includes a second internal electrode exposed to the third surface and fourth surface to be connected to the first external electrode and the second external electrode.

4. The multilayer electronic component of claim 3, wherein the first dummy electrode includes a first-first dummy electrode disposed between the first internal electrode and the third surface, and a first-second dummy electrode disposed between the first internal electrode and the fourth surface.

5. The multilayer electronic component of claim 3, wherein the second internal electrode is disposed to be spaced apart from the fifth surface and the sixth surface.

6. The multilayer electronic component of claim 3, wherein the second internal electrode layer is formed of the second internal electrode.

7. The multilayer electronic component of claim 1, wherein at least one of the first surface and the second surface has, at least partially, a concave shape in an inward direction of the body.

8. The multilayer electronic component of claim 1, wherein, on the plane perpendicular to the third direction, the body includes, at least partially, a region having a length in the first direction that decreases from both end portions in the second direction toward a central portion of the body in the second direction.

9. A multilayer electronic component comprising:
a body including a dielectric layer and a first internal electrode layer and the second internal electrode layer alternately disposed in a first direction with the dielectric layer interposed therebetween, the body having a first surface and a second surface opposing each other in the first direction, a third surface and a fourth surface connected to the first surface and the second surface, the third surface and the fourth surface opposing each other in a second direction, and a fifth surface and a sixth surface connected to the first surface, the second surface, the third surface, and the fourth surface, the fifth surface and the sixth surface opposing each other in a third direction;
a first external electrode and a second external electrode respectively disposed on the third surface and the fourth surface, the first external electrode and the second external electrode configured to extend to first portions of the first surface and the second surface; and
a third external electrode and a fourth external electrode respectively disposed on the fifth surface and the sixth surface, the third external electrode and the fourth external electrode configured to extend to second portions of the first surface and the second surface,
wherein, on a cross-section in the first direction and the second direction facing at least one of both end portions in the third direction of the multilayer electronic component which includes the body and the first external electrode, the second external electrode, the third external electrode, and the fourth external electrode:
a length in the first direction of each of both end portions in the second direction of the body is greater than a length in the first direction of a central portion in the second direction of the body,
a first maximum length in the first direction of each of regions of the third external electrode and the fourth external electrode, configured to extend to a first portion of the first surface, is greater than a second maximum length in the first direction of each of regions of the first external electrode and the second external electrode, configured to extend to a second portion of the first surface,
a third maximum length in the first direction of each of regions of the third external electrode and the fourth external electrode, configured to extend to a first portion of the second surface, is greater than a fourth maximum length in the first direction of each of regions of the first external electrode and second external electrode, configured to extend to a second portion of the second surface, and
both ends in the first direction of each of the third external electrode and fourth external electrode do not exceed both ends in the first direction of each of the first external electrode and second external electrode.

10. The multilayer electronic component of claim 9, wherein
a first average length in the first direction of each of the regions of the third external electrode and the fourth external electrode, configured to extend to a third portion of the first surface, is greater than a second average length in the first direction of each of the regions of the first external electrode and second external electrode, configured to extend to the third portion of the first surface, and
a third average length in the first direction of each of the regions of the third external electrode and fourth external electrode, configured to extend to a fourth portion of the second surface, is greater than a fourth average length in the first direction of each of the regions of the first external electrode and second external electrode, configured to extend to the fourth portion of the second surface.

11. The multilayer electronic component of claim 9, wherein:
the first internal electrode layer includes a first internal electrode exposed to the fifth surface and sixth surface to be connected to the third external electrode and fourth external electrode, and a first dummy electrode disposed to be spaced apart from the first internal electrode, and
the second internal electrode layer includes a second internal electrode exposed to the third surface and fourth surface to be connected to the first external electrode and the second external electrode.

12. The multilayer electronic component of claim 11, wherein the first dummy electrode includes a first-first dummy electrode disposed between the first internal electrode and the third surface, and a first-second dummy electrode disposed between the first internal electrode and the fourth surface.

13. The multilayer electronic component of claim 11, wherein the second internal electrode is disposed to be spaced apart from the fifth surface and the sixth surface.

14. The multilayer electronic component of claim 11, wherein the second internal electrode layer is formed of the second internal electrode.

15. The multilayer electronic component of claim 9, wherein at least one of the first surface and the second surface has, at least partially, a concave shape in an inward direction of the body.

16. The multilayer electronic component of claim 9, wherein on a cross-section in the first direction and the second direction facing at least one of both end portions in the third direction of the multilayer electronic component which includes the body and the first external electrode, the second external electrode, the third external electrode, and the fourth external electrode, the body includes, at least partially, a region having a length in the first direction that decreases from both end portions in the second direction toward a central portion of the body in the second direction.
